(19) United States
(12) Patent Application Publication
(10) Pub. No.: US 2008/0016022 A1
(43) Pub. Date: Jan. 17, 2008

(54) Systems and methods for providing information about patent examiners

(76) Inventor: Christopher Holt, Edina, MN (US)

Correspondence Address: WESTMAN CHAMPLIN & KELLY, P.A., SUITE 1400, 900 SECOND AVENUE SOUTH, MINNEAPOLIS, MN, 55402-3319, US

(21) Appl. No.: 11/487,526

(22) Filed: Jul. 14, 2006

(51) Int. Cl. G06F 17/30

(52) U.S. Cl. 707/1

(57) ABSTRACT

A data accessing system provides information about patent examiners. The system includes a user interface and a data search component. The user interface is accessible over a wide area network and is configured to receive a patent examiner identification input identifying a patent examiner, and a data request. The data search component is configured, in response to the data request, to retrieve patent-related writings generated by the patent examiner is prosecuting a plurality of different patent applications.

### BACKGROUND

It is natural for a person who is tasked with influencing a decision-maker to be curious about the decision-maker's background. Further, if the person is pre-equipped with insight into the decision-maker's previous decisions, this could give an advantage in terms of the person's ability to effectively advocate for a particular outcome. It comes as no surprise that entire industries have sprung up around providing information about decision-makers.

An attorney who is to appear before a judge has a variety of resources available from which information about the judge can be learned. For example, it is generally not difficult for the attorney to obtain previous written opinions authored by the judge. In fact, it is relatively easy to obtain previous written opinions specifically dealing with topics that are on-point or similar to the attorney's current needs or interests. There are well-known commercial and public resources for acquiring this type of information.

Further, there are a variety of resources available that provide information related to a given judge's personal background. In some jurisdictions, there are court web sites that provide background information about judges. Periodicals, such as those published by bar associations, often publish interviews and/or judicial profiles. In addition, certain specialized commercial and public informational services provide the public with background information about lawyers and/or judges.

Another kind of decision maker is a patent examiner. A patent examiner, typically an employee of a patent office, is tasked with reviewing patent applications and making decisions related to the patent process. An examiner is typically tasked with, among other things, deciding how many inventions are claimed in a given application, deciding whether the application satisfies certain formal requirements, deciding whether a patent should be granted to cover any invention claimed in the application, and deciding the scope of any patent to be granted.

In many countries, including the United States, as a patent examiner makes decisions during the patenting process, an inventor and/or an advocate (e.g., a representative of an inventor and/or a representative of an assignee of an inventor's rights) is given opportunities to interact with the examiner. At least some of these interactions represent opportunities to urge the examiner toward a particular outcome or decision.

Under the circumstances, it is natural for a person who is tasked with interacting with a patent examiner to be curious about the examiner's background and/or previous decisions. Unfortunately, at least in the United States, there is currently no convenient way to efficiently gather information on an examiner-specific basis. In fact, it is not uncommon for an inventor or an advocate to know very little about the examiner with whom they are interacting during the process of moving a patent application through the patenting process.

### SUMMARY

A data accessing system provides information about patent examiners. The system includes a user interface and a data search component. The user interface is accessible over a wide area network and is configured to receive a patent examiner identification input identifying a patent examiner, and a data request. The data search component is configured, in response to the data request, to retrieve patent-related writings generated by the patent examiner in prosecuting a plurality of different patent applications.

### BRIEF DESCRIPTION OF THE DRAWINGS

FIG. 1 is a schematic diagram of an information-gathering environment.

FIG. 2 is a schematic representation of data collection in the case of the United States Patent and Trademark Office (USPTO).

FIG. 3A is a flow diagram illustrating steps implemented by system in order to facilitate user registration.

FIG. 3B is a flow diagram illustrating steps implemented by system in order to facilitate a special case registration, such as a registration of a user who is a patent examiner.

FIG. 4 is a diagrammatic illustration demonstrating contents of a database.

FIG. 5 is a diagrammatic illustration of an example screenshot in the form of a search interface.

FIG. 6 is a schematic representation of one examiner data sheet illustratively extracted from the collection of data sheets maintained in a database.

### DETAILED DESCRIPTION OF ILLUSTRATIVE EMBODIMENTS

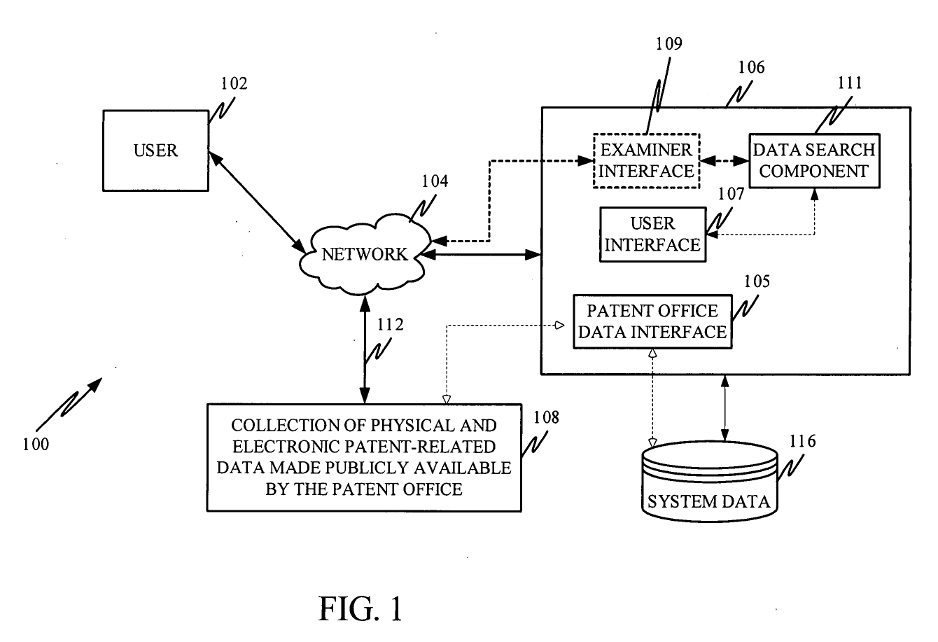

FIG. 1 is a schematic diagram of an information-gathering environment 100. Block 102 represents a user utilizing a client computing device. Block 106 represents an examiner information system maintained on one or more server-type computing devices. A user 102 interacts with examiner information system 106 in order to acquire information about one or more patent examiners employed by a patent office. This interaction occurs over a computer network 104, which is illustratively, but not necessarily, the Internet. Examiner information system 106 is illustratively, but not necessarily, implemented as an Internet web site.

While user 102 could be any person interested in the patent system or process, user 102 is likely to be an inventor, an agent representing an inventor or an agent representing an entity to whom patent rights have been assigned. For the purpose of the present description, these different classes of potential users 102 will all be referred to as advocates. They are all advocates in that they are all in a position that requires them to negotiate with the patent office. The representative of the patent office in these negotiations is typically the patent Examiner.

As a rule, patent offices make at least some patent-related data publicly available. Data collection 108 represents that data. Some of the data may be electronically available and/or available over a computer network (e.g., the Internet). Some of the data may be available in a non-electronic format and/or through means other than a computer network, (e.g., physical copies purchased for a fee, data purchased or obtained on a physical storage mechanism, etc.). As is generally indicated by line 112, when components of collection 108 are made electronically available to the public, a user 102 and examiner information system 106 can retrieve that data, often through a database querying process. It should be noted, however, that in some cases data may be available through some other electronic means, such as through downloads from an FTP server.

Examiner information system 106 preferably includes a number of components. Specifically, examiner information 106 preferably includes patent office data interface 105 that is configured to interact with publicly available sources of patent examiner information and store, or otherwise catalog, the public information in system data store 116. In one embodiment, patent office data interface 105 includes, or otherwise comprises, an automated algorithm or module that performs automated searching, retrieval, cataloging and storing of publicly available data in such a way as to facilitate efficient storing and speedy recollection of such information based on serial numbers, and/or examiner names. For example, in one embodiment, interface 105 may include a crawler, or sorts, that periodically, or continuously, crawls through sources of publicly available information looking for examiner-written documents, or other suitable sources of information that become available and have not been previously stored in system data store 116. When module 105 finds such information, it downloads, categorizes and stores information in system data store 116.

Examiner information system 106 also preferably includes a user interface module 107 that provides a user interface to standard users of examiner information system 106. Additionally, examiner information system 106 also includes a dedicated examiner interface 109 that allows patent examiners to log in and interact with system 106 in a manner that is different than that with which regular users can interact via interface 107. Each of interfaces 107 and 109 is preferably coupled to data search component 111 that may comprise a local search engine, or a module that simply formulates remote search requests to be executed against system data store 116 and/or remote sources of publicly available data, such as source 108.

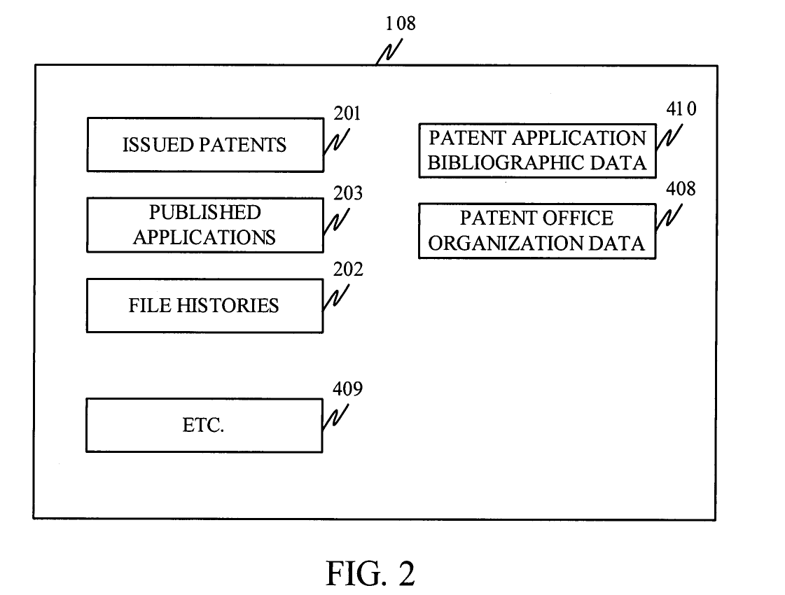

FIG. 2 is a schematic representation of data collection 108 in the case of the United States Patent and Trademark Office (USPTO). Currently, the patent office in the United States provides public access to very large amounts of patent-related data. Much of this data is freely available through their website (www.uspto.gov) either through database querying, FTP downloads, requests for non-electronic copies, requests for data on an electronic storage means, or some other means. Some of the available data shown in FIG. 2 includes issued patents 201, published patent applications 203, patent application file histories 202, patent application biographic data 410 and patent office organization data 408. Other data is represented at 409.

Currently, through the USPTO website, queries can be run to selectively search through patents that have issued over a date range of more than a hundred years (more than six million patents are currently included in the searchable patent collection). Further, queries can currently be run to selectively search through published patent applications (many applications are, by law made public after 18 months). Still further, currently, for many pending applications and issued patents, the web site provides access to copies of documents in the file history (documents created during the patent filing, examination and/or issuance processes). There is no question that the U.S. patent office provides broad access to very rich patent-related data. Much of the data is available on-line for free, immediate acquisition by anyone. That which is not available on-line is often available in another format (e.g., a person can often contact the Patent Office and for a fee, obtain physical copies of documents, copies of documents on an electronic storage medium, etc.).

Thus, it may technically be possible for a user 102 to obtain some level of information about a particular patent examiner from data collection 108. However, in many cases, there is no efficient means for user 102 to navigate through data collection 108 on an examiner-specific basis. To the extent that the patent office electronic data systems support examiner-specific querying (e.g., on the patent office web site), the information that is available is quite limited. Further, accessing this type of information requires non-intuitive data navigation and/or execution of multiple queries in order to focus on information that is pertinent to current interests or needs. Most information is instead made available primarily by reference to an application serial number, a patent number, or the like, but not based on a link to a particular patent examiner.

An example will help to illustrate the dilemma. Suppose a user 102 is interested in knowing how a particular patent examiner has previously made patent-related decisions in cases involving a particular kind of technology. In many patent office systems (including the current U.S. system), in order for the user to gain this type of insight from publicly available information, multiple queries must be performed. Often, a first query or queries must be executed in order to first identify patent application serial numbers and/or patent numbers associated with the examiner. Then, those serial numbers and/or patent numbers must be queried in order to determine which cases are relevant to the desired technology area. This process is cumbersome and imprecise. The fact that it is currently so difficult to gain insight from data on an examiner-specific basis may even be a contributing factor to the fact that so few advocates know much of anything about the patent examiner with whom they are working during prosecution of a patent application.

This is where examiner information system 106 comes into play. But, in one embodiment, before user 102 can take advantage of the services provided by system 106, he or she must become a registered user. In one embodiment, all or some services provided by system 106 may not require user registration. However, in another embodiment, at least some users are forced to register before access to system 106 is granted.

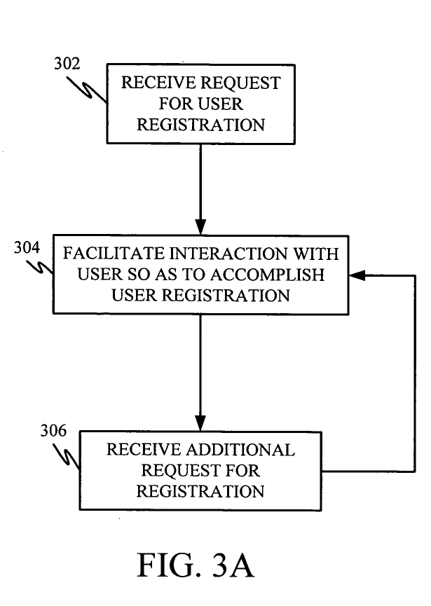

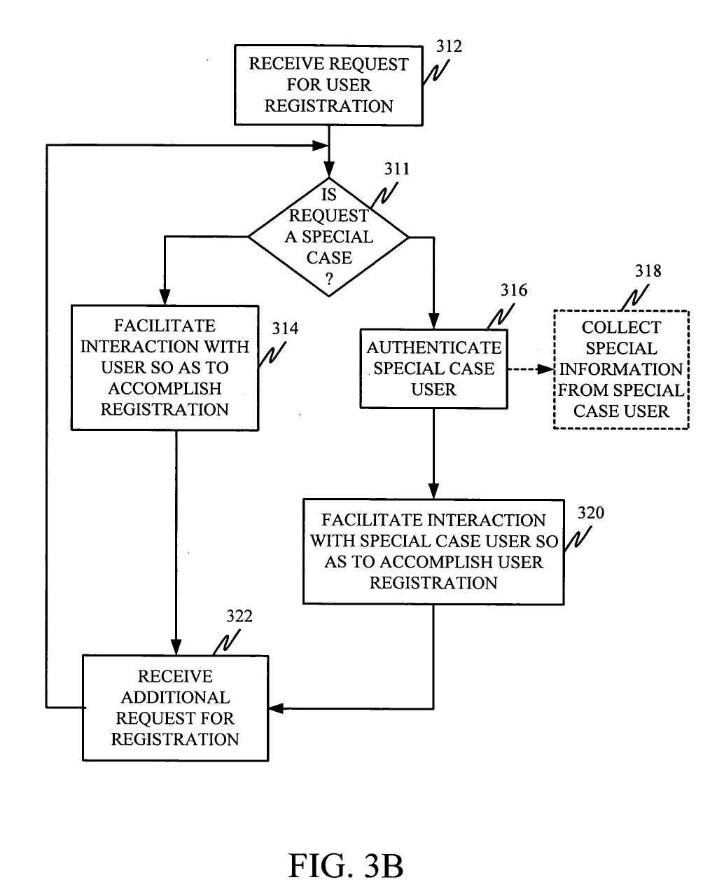

FIG. 3A is a flow diagram illustrating steps implemented by system 106 in order to facilitate user registration. In accordance with block 302, a request for registration is received. This may simply be, for example, user 102 navigating to a web page that serves as a home page for system 106 and actuating a user interface element (e.g., clicking on an icon) to request registration. Of course, other ways of requesting registration are contemplated as well.

In accordance with block 304, system 106 facilitates interaction with user 102 in order to accomplish user registration. In one embodiment, the registration process involves user 102 providing personal and/or payment details in order to set up an account. In one embodiment, registration involves providing user 102 with a password for log-in purposes (e.g., a password that may or may not expire after a certain period of time), although any other authentication mechanism can be used as well. In one embodiment, registration involves obtaining an indication that user 102 agrees to accept certain terms of use, etc. In accordance with block 306, an additional request for registration is received (e.g., from a different user). As is indicated, the user registration process is repeated as necessary to register all interested users.

FIG. 3B is a flow diagram illustrating steps implemented by system 106 in order to facilitate a special case registration, such as a registration of a user who is a patent examiner. Consistent with block 312, the 3B process is similar to the 3A process in that it begins with receipt of a request for user registration. In accordance with block 311, however, a determination is made as to whether the request is a special case request for registration. In one embodiment, special case requests for registration may be requests for registration made by patent examiner).

Special case requests for registration may originate from a different web page than regular requests. For example, examiners might initiate a request from a web page intended specifically as an examiner interface (shown in dashed lines as examiner interface 107 in FIG. 1) to system 106. However, in another embodiment, a single interface (e.g., a single web page) has two different buttons that can be pushed in order to request registration (one button for regular users and another button for special case users). In one embodiment, a regular user must pay full price for registration/access but a special case user gets free or discounted registration/access.

The system can illustratively be configured such that access rights provided to regular users are different than access rights provided to special case users. In one embodiment, instead of just one class of special case users, the system can support multiple classes of special case users with different registration terms and/or access rights (e.g., an examiner class, an attorney class, an independent inventor class, etc.).

As is indicated by block 314, if the registration request is not special case, then system 106 simply facilitates regular user registration in a manner similar to that described relative to block 304 of FIG. 3A. In accordance with block 322, when another request for registration is received (e.g., from a different user), the process is repeated. For regular users, the processes of FIGS. 3A and 3B are substantially similar.

As is indicated by block 316, if the request for registration is a special case, then the special case user is authenticated. For example, if an examiner is requesting access, then the fact that the user is an examiner is authenticated. The present invention is not limited to any particular means of authentication. The requesting examiner may simply be called on the telephone (e.g., at a phone number listed in USPTO phone directory) to verify that an examiner actually did request access. Of course, special case registration is ultimately limited to instances where authentication is successful.

It should be noted that authentication is an optional step in the registration of special case users. It is conceivable that the identity of a particular class of special case users may be assumed based on grounds other than direct authentication. For example, reliance might be placed on an honor system (e.g., no authentication but it is assumed that people won't lie about their special case qualifications). Alternatively, special case qualifications might be assumed based on one's entry point to the registration system (e.g., individuals who access from a Web location tailored to a special case theme are assumed to be special case users).

In one embodiment, a special case user (or a regular user for that matter) is required to provide something other than monetary payment in return for being granted access to system 106. For example, a user might be required to provide information (e.g., high-level biographical information). For special case users, one incentive for providing information may be to obtain free access or access that is discounted relative to what regular users pay. For special case users, this information-gathering step is indicated by block 318 and is described in greater detail below. In one embodiment, to get a special case registration, the special case user must also waive confidentiality in information that they provide.

In the scenario where examiners are treated as special case users, an examiner might barter information related to their educational and/or employment background (where they went to college, what degrees they obtained, what year they started at the patent office, etc.) in exchange for free or discounted access. The examiner would also waive confidentiality in the information. The information can then be made available to other registered users.

In one embodiment, system 106 receives a registration request from a special case user 102 (e.g., an examiner). System 106 then facilitates receipt of the user's name and/or email address. In one embodiment, special case users are required to have an email address that is consistent with their special case status (e.g., examiners must have an email address consistent with addresses issued by the patent office). System 106 then facilitates a sending of an authentication email to the user's email address (e.g., email to the examiner's USPTO email address). Next, after a reply email has been received confirming a desire for a special case registration, system 106 sends another email to the same address. This second email contains an access password. In one embodiment, however, when the examiner attempts to use the password, system 106 is configured to withhold actual system access until the special case user provides a response to one or more questions. In one embodiment, the user must also provide an indication that they agree for their answers to the questions to be made available to other registrants of the system (e.g., the answers are added to a data sheet maintained in the system for review by other users 102).

In accordance with block 320, system 106 facilitates interaction with the special case user as necessary to complete the registration process. Interaction may occur before, during or after authentication. As is indicated by block 322, the process is illustratively repeated as necessary to register all users.

In one embodiment, regardless of whether a user is special case or regular, the goal of registration is to obtain a password. The password is utilized to log-in to system 106 in order to access related content. For example, in one embodiment, a user uses an Internet browser to access a Web page associated with system 106. Then, the user enters password information and, assuming an active account in good standing, is granted access to content (e.g., information about patent examiners).

Those skilled in the art will appreciate that the present invention is not limited to password authentication. For example, users could be supplied with a personalized peripheral device with a USB interface, a personalized smart card, or some other physical authentication mechanism to be engaged to a computer to support an authentication/log-in process. Passwords are, at the present time, simply the most common means for personal authentication during a log-in process. This may change with time and the present invention contemplates such changes.

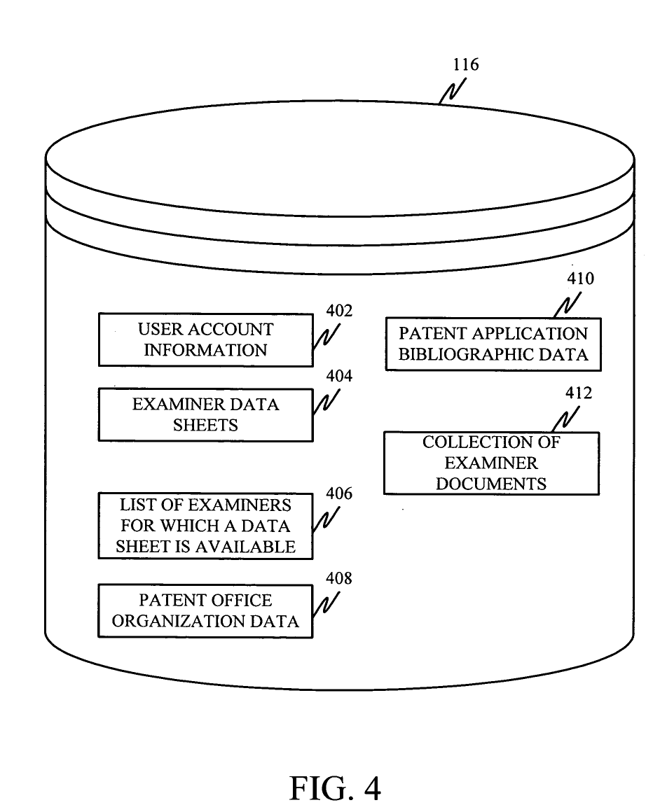

As is shown in FIG. 1, a database 116 is made accessible to system 106. Database 116 contains information utilized by system 106 as necessary to support the services provided to user 102. FIG. 4 is a diagrammatic illustration demonstrating contents of database 116.

As is shown in FIG. 4, database 116 contains user account information 402. When user 102 logs in to system 106, system 106 is configured to check information 402 to be sure that the user's account is in good standing. If the account is not in good standing, the user is denied access to services until applicable insufficiencies are remedied. The remedy could mean submitting additional payment to extend a service subscription. However, the remedy could also or alternatively mean providing additional information to be published to other registered users (e.g., examiners must tell more about themselves in order to extend a free or discounted subscription).

System 106 is also configured to reference information 402 as necessary to enforce access right restrictions relative to a given registered user. In one embodiment, access rights are assigned based on how much monetary payment a user submits (e.g., certain premium content or types of interaction may be reserved for users that pay a higher price). In another embodiment, access rights are assigned based on how much information a user submits (e.g., certain premium content or types of interaction may be reserved for users that answer more questions and give consent for such answers to be published to other registered users). In one embodiment, special case users are provided with a set of access rights that are different than the rights assigned to regular users.

As is shown in FIG. 4, database 116 also includes examiner data sheets 404. An examiner data sheet is illustratively a compilation of information about a particular examiner. Upon a valid log-in, user 102 is able to search for and access an examiner data sheet for a particular examiner.

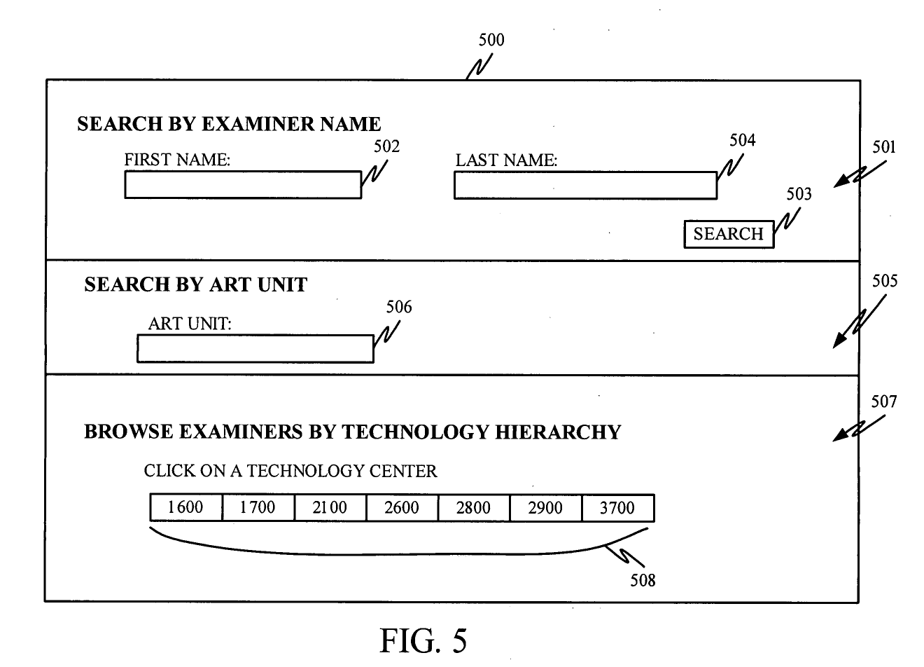

FIG. 5 is a diagrammatic illustration of an example screenshot in the form of a search interface 500. Search interface 500 is an interface provided to logged-in user 102 to support retrieval of a particular examiner data sheet as desired. As is reflected in interface 500, there are a variety of different options for getting to a desired examiner data sheet. Those skilled in the art will appreciate that the other options could be utilized without departing from the scope of the present invention.

Interface 500 includes a name-search area 501. As is shown in FIG. 4, the database 116 available to examiner information system 106 illustratively includes a listing of examiners for which a data sheet is available. When user 102 enters a name into an input box 502 and/or an input box 504 and then presses a search button 503, then system 106 searches list 406. Examiner names that are determined to be a match are then displayed to user 102. The user then selects (e.g., clicks on) one of the displayed examiner names and that examiner's data sheet is retrieved from database 116 and displayed to the user. In one embodiment, if the user searches for a name that appears only once in list 406, then that examiner's data sheet is displayed immediately such that the selection step is eliminated. Those skilled in the art will appreciate that any known means for accomplishing record retrieval by name is to be considered within the scope of the present invention. For example, algorithms can be employed to detect and account for misspellings during the searching process.

Interface 500 also includes an art unit search area 505. In the United States, the number of patent examiners employed by the Patent Office is in the thousands. The Office has hierarchically organized the examiners based on technological subject matter. More specifically, the Office has been organized into eight “technology centers,” which been assigned numbers 1600, 1700, 2100, 2600, 2800, 2900, 3600 and 3700. The examiners working in technology center 1600 primarily deal with matters related to biotechnology and organic chemistry. The examiners working in technology center 2100, on the other hand, primarily deal with matters related to computer architecture, software, and information security. The other technology centers are similarly focused on a narrow category of subject matter.

Each technology center is further divided into sub-divisions called art units. For example, some examiners within technology center 1600 are more specifically assigned to art unit 1620, which is even more narrowly focused on matters pertaining to organic chemistry. Still further, within art unit 1620, some examiners are assigned to 1624 (heterocyclic organic compounds) while others are assigned to 1625 (heterocyclic compounds and other uses).

Art unit search area 505 supports searching by art unit or technology center. Another kind of data maintained in database 116 is patent office organization data 408. Data 408, as is shown in FIG. 2, is included in the body of information 108 offered to the public by the patent office. Thus, as is reflected in FIG. 4, data 408 can simply be copied to database 116. Of course, as additions or changes are made by the Patent Office, it is desirable to update the copy in database 116 accordingly.

To use search area 505, the user enters an art unit or technology center value into box 506 and request that a search be done (e.g., presses the enter key). Examiner information system 106 receives that information and performs a search. These searches can be locally directed at the data in database 116 or can be remotely directed at data included within information 108 (e.g., searching through a Web-based search interface sponsored by the patent office). In one embodiment, the result of the search is a determination and display of a list of examiners assigned to the indicated art unit or technology center. The user select (e.g., click) one or more examiners and a corresponding data sheet is retrieved from database 116 and displayed to the user.

Interface 507 also includes an organizational hierarchy browsing area 507. In this case, the user selects (e.g., clicks) on one of the technology center indications 508. Examiner information system 106 receives that input and queries data 408 for a listing of related art units. In one embodiment, the system is configured such that examiner names are optionally shown or not shown (depending on user preference) on the display of the listing of all art units within a technology center. Assuming the examiner names are not shown, the user can select (e.g., click) an indicated art unit. System 106 then retrieves associated examiner names and displays them appropriately. The user can illustratively drill up and down through the organizational hierarchy and system 106 will query data 408 and facilitate generation of displays of information consistent with the user selections. During this process, whenever an examiner name is displayed, the user can selects (e.g., clicks) a name to cause system 106 to retrieve and display a corresponding data sheet.

In one embodiment, a search in area 505 can lead into browsing consistent with the experience associated with searching in area 507. For example, in one embodiment, entering 2100 into box 506 and initiating a search leads to a display of all related art units without a full display of all corresponding examiner names. The user can then, similar to the experience associated with area 507, drill up and down as necessary to find an examiner name for which a data sheet is desired. Those skilled in the art will appreciate that the searching functionality of areas 501, 505 and 507 can be combined in many different combinations.

Another kind of data maintained in database 116 is patent application bibliographic data 410. Data 410, shown in FIG. 2, is included in the body of information 108 offered to the public by the patent office. Thus, as is reflected in FIG. 4, data 410 can simply be copied to database 116. Of course, as additions or changes are made by the Patent Office, it is desirable to update the copy in database 116 accordingly.

Data 410 illustratively includes a collection of bibliographic information related to each patent application (potentially including some applications that have or have not issued into patents) on a serial number by serial number basis (each patent application is assigned a unique serial number). The nature of the bibliographic information will depend on what the Patent Office decides to publish in the bibliographic format. In one embodiment, the bibliographic data includes, for each application serial number, any combination of the name of the assigned examiner, the filing data of the application, a listing of inventors, a listing of any entity to which the application has been assigned, the title of the application, or any other descriptor of related information.

Though not specifically illustrated, search interface 500 (or a separate search interface) can be configured to enable user 500 to search for examiners based on one or more attributes reflected in the bibliographic data. These searches can be locally directed at the data in database 116 or can be remotely directed at data included within information 108 (e.g., searching through a Web-based search interface sponsored by the patent office). For example, in one embodiment, system 106 is illustratively configured to enable a user to request and receive a listing of all patent examiners that have ever examined a patent application that was assigned to “XYZ Corporation.” To do this, system 106 queries bibliographic data 410, identifies serial numbers associated with applications assigned to “XYZ Corporation,” and then compiles a list of related examiners as noted in data 410.

In another embodiment, a user is able to key word search through applications titles as included in bibliographic data 410. The search results will include an indication of examiners associated with applications having a title that satisfies a threshold required to be considered a match. Any means of querying bibliographic data 410 to get to an examiner name is within the scope of the present invention. Examiner names can then be selected (e.g., clicked on) in order to cause system 106 to retrieve and display a corresponding examiner data sheet.

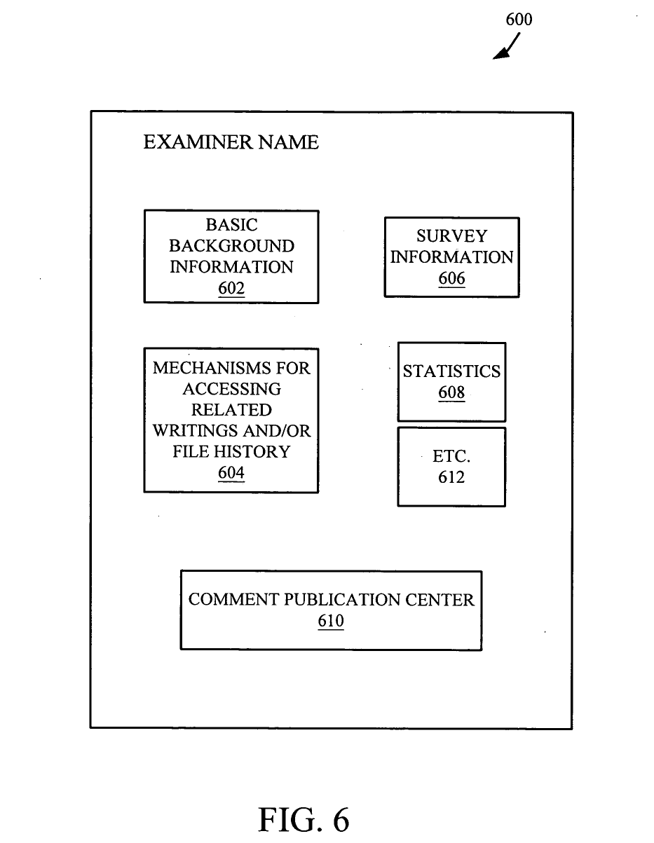

FIG. 6 is a schematic representation of one examiner data sheet 600 illustratively extracted from the collection 404 of data sheets maintained in database 116. Each data sheet is essentially a user interface (e.g., might be a single Web page view but could just as easily be multiple pages linked together) that provides information about a particular examiner. FIG. 4 shows examiner data sheets as distinct documents maintained in database 116. Those skilled in the art will appreciate that this need not necessarily be the case. For example, an examiner data sheet can be implemented as a generic user interface component having data fields that are filled in for a particular examiner in response to a request from a user for that examiner's data sheet. The data utilized to fill the interface fields can be locally obtained (e.g., from data stored in database 116) or obtained remotely, for example from data included within information 108 (e.g., obtained by querying a Web-based search interface sponsored by the patent office). These and any other actual implementation of the concept of examiner data sheets are within the scope of the present invention.

Data sheet 600 illustratively pertains to one particular examiner whose name is indicated somewhere in the interface. In one embodiment, a photograph of the examiner is also included. Data sheet 600 is but an example of what a data sheet can include. A data sheet can, of course, actually include more, fewer and/or different components without departing from the scope of the present invention.

Data sheet 600 includes an area 602 for basic background information. The precise content of area 602 is not critical to the present invention. Information 602 can include, for example, the year the examiner started at the patent office, the institutions where the examiner received his or her education, the educational degrees obtained by the examiner, publications authored by the examiner, etc. In one embodiment, when no information is available to be included in area 602, the area can be excluded entirely or partially. Alternatively, some or all of the area can be grayed out and designated with a “not yet available for this examiner” indication.

In one embodiment, some or all information collected from an examiner during a special case registration (described in relation to FIG. 3B) is published in area 602 of his or her data sheet. In one embodiment, examiner information system 106 can be configured to arrange this publication automatically as the data comes in. In another embodiment, publication occurs only after the system receives approval from a system administrator.

It should be noted that it is within the scope of the present invention to employ techniques other than the special case registration process to gather data for publication in area 602. For example, in one embodiment, an examiner is sent a promotional email advertising their right to free or discounted access to system 106. The examiner illustratively accesses a registration Web page through information provided in the email (e.g., the examiner clicks on a link and opens a registration page in a browser application). Information for publication is then provided through interaction with the registration page. Authorization for publication is illustratively provided. Publication to that examiner's data sheet then occurs (may require approval by system administrator). The examiner illustratively receives his or her access credentials when the registration process is complete.

As a patent application moves through the patent office, a trail of documents is created. This trail of documents collectively make up what is called a file history. Each application has its own file history. Each file history is identifiable at least by the unique serial number assigned to the corresponding application. Every serial number, including those that correspond to an issued patent, has an associated file history.

As is reflected by box 202 in FIG. 2, at least some file histories are made available to the public. For example, in the United States, through a search portal located on the Patent Office Web Site, a user can electronically retrieve and review documents in at least some file histories. In most cases, file histories are retrieved based on input from the user in the form of an application serial number or a patent number. Some file histories may not be publicly available in electronic format but may be available by request in hard copy. Some file histories may not be publicly available at all. For example, in the United States, many file histories are held in confidence by the Patent Office for the first eighteen months after filing. Some file histories are maintained in confidence until issuance of a related patent.

It is common for a file history to contain one or more documents authored by an examiner assigned to the associated application. For example, during the examination process, an examiner will issue documents called Office Actions. These Office Actions are part of the file history.

In accordance with one embodiment of the present invention, at least some documents authored by examiners are extracted from file histories and maintained in database 116 as examiner documents 412 (see FIG. 4). Thus, examiner documents 412 are accessible to examiner information system 106. In one embodiment, each document in collection 412 is identifiable by its associated serial number, its associated examiner(s), and/or its associated date of creation.

Area 604 on (See FIG. 6) is an interface through which a user can access file history documents (especially but not necessarily limited to examiner-authored documents) on an examiner-specific basis. In one embodiment, for the examiner that is the subject of the data sheet, area 604 includes serial numbers associated with one or more affiliated patent applications. In order to compile information for display in area 604, system 106 illustratively performs a query against data 412 to determine the serial numbers associated with the examiner affiliated with data sheet 600. The result of this query is displayed (e.g., as links to related documents) in area 604.

In another embodiment, system 106 queries patent application bibliographic data 410 (this could be a local or remote query) to determine all serial numbers associated with the examiner (not just serial numbers reflected in collection 412). Then, all serial numbers are displayed to the user in area 604. The serial numbers for which related documents are available for review illustratively have a different appearance (e.g., appear as links) as compared to serial numbers for which documents are not available. In one embodiment, the appearance of a given serial number is indicative of what documents are available to the user of system 106, and/or indicative of from where documents are available for that serial number. For example, serial numbers for which there are corresponding documents in collection 412 may have a different appearance as compared to serial numbers for which system 106 is configured to facilitate remote retrieval of related documents. In addition or alternatively, serial numbers for which full file histories are available may have a different appearance that serial numbers for which only office actions are available. By displaying all serial numbers, the user gains some insight into the examiner's level of experience.

Each serial number that appears in area 604 and has one or more corresponding documents in collection 412 is illustratively a link that can be navigated to the locally stored documents. In one embodiment, this navigation is direct. For example, there is an immediate display of one or more documents in a browser window(s) that is separate from a browser window in which data sheet 600 is displayed. However, as will be described in greater detail below, the navigation may be indirect, such as through an additional document selection display that appears after a link is selected.

Area 604 can illustratively be configured to display only a limited set of serial numbers. In one embodiment, the scope of the limited set is configurable by the user (e.g., 10 most recent, no more than 50, etc.). Because serial numbers are issued in an order that is essentially consecutive in nature, it is relatively easy to configure system 106 to display information indicating how recently a document was created. Further, because at least the data in collection 412 includes information pertaining to when documents were created, it is also relatively easy to configure system 106 to display at least some level of information in accordance with a particular range of dates (e.g., a date range provided by the user). These are just examples of sorting possibilities and embodiment of the present invention are not limited to these examples.

It should be emphasized that the described document retrieval functionality need not necessarily be limited to documents contained in collection 412. The system could just as easily be configured to retrieve data from a remote source, such as through a search portal or other query service provided by the patent office or a commercial provider. Also, retrieval may be from a combination of sources (e.g., documents retrieved from collection 412 when available but otherwise from a remote source) (e.g., after viewing a document from collection 412, a user can initiate a remote retrieval by system 106 of all or some related file history documents).

An alternate configuration for area 604 will now be described. In this configuration, the user still first selects a serial number in order to access examiner-relevant documents. As has been described, upon selection, the display of one or more corresponding documents may be automatic (e.g., automatically displayed in one or more separate browser windows). Alternatively, however, the user is first presented with a menu from which a particular document is selected for display.

In one embodiment, the menu simply contains a listing of retrievable Office Actions or other documents (e.g., applicant responses) contained in collection 412. However, the menu may contain a more extensive listing of documents in the file history. In one embodiment, this listing is stored, maintained and retrieved from collection 408 (in which case that data would need to be updated periodically). Alternatively, however, information to be incorporated into the listing is retrieved (e.g., on a serial number basis) from a search interface to data 108 (e.g., through a query server sponsored by the patent office).

Some of the documents in the listing will illustratively be immediately accessible to the user from collection 412 (e.g., upon selection, system 106 immediately retrieves and displays the relevant document, for example, in a separate browser window). Other documents may be remotely accessible from a search interface to data 108 (e.g., upon selection, service 106 automatically performs a remote query on the user's behalf and returns the resulting document(s), for example, in a separate browser window). Some documents may not be available at all (e.g., only documents that appear as links are available . . . local links may or may not have a different appearance than remote links).

In another embodiment, area 604 alternatively or additionally provides other avenues for getting to examiner-specific documents that might be relevant to a user's particular needs or desires. As was previously described, patent application bibliographic data 410, contains a directory of information on an application-specific basis. In one embodiment, at a minimum, data 410 contains for each application an indication of the serial number and the assigned examiner. In accordance with one aspect of the present invention, any additional included information can be cross-referenced against the serial number/examiner information and then leveraged through a user interface within area 604 as an alternative means for accessing examiner-specific documents.

For example, in one embodiment, for each application, bibliographic data 410 also includes patent number if a patent has issued. Thus, area 604 can display patent numbers with which the examiner is associated. In one embodiment, those patent numbers are linked to documents in a manner similar to the linking of serial numbers described above. Thus, examiner-specific data can be accessed on a patent number-specific basis.

In another embodiment, for each application, bibliographic data 410 also includes a assignee information. Thus, area 604 can display assignees for which the examiner has or is examining applications. User selection of an assignee illustratively causes system 106 to display an associated set of serial or patent numbers (e.g., serial or patent numbers for which the relevant examiner and assignee are both associated). That limited set of serial numbers is then linked to documents in a manner similar to the linking described above. Thus, examiner-specific data can be accessed on an assignee-specific basis.

The display of assignees within area 604, or any other display for that matter, can be limited based on certain parameters reflected in the bibliographic data. For example, assuming the bibliographic data contains a field for patent number, system 106 can easily be configured (e.g., based on an indicated user or system administrator preference) to limit any displayed list (of serial numbers, of assignees, etc.) to only those associated with an issued patent. Of course, those skilled in the art will appreciate that this is just one of many potential possibilities for combinations upon which displayed data can be sorted. In addition, the richer the bibliographic data, the more potential for interesting combinations.

In another example, a display of assignees can be limited to assignees with which the examiner has frequently worked. For example, the display might only show assignees for which the examiner has more than “x” number of serial numbers. The value “x” is illustratively configurable (e.g., by a user or by a system administrator). In another example, the assignee display might be configured to show only serial numbers for applications that lead to issuance (e.g., system 106 filters based on whether patent number is listed).

In another embodiment, for each application, bibliographic data 410 also includes title information. Thus, area 604 can display titles (e.g., most recent titles or titles with a word or words that appear frequently in the examiner's associated applications, etc.) or common key words associated with applications that the examiner has or is examining. User selection of a title or key word(s) illustratively causes system 106 to display an associated serial number or numbers that are then linked to documents in a manner similar to the linking described above. When a title is selected, however, it may be possible to eliminate the serial number selection step and move straight into document display or selection. Thus, examiner-specific data can be retrieved through area 604 on a title-specific or key word-specific basis.

In one embodiment, system 106 supports a user's ability to perform a word search against the examiner's collection of titles. When the user identifies an interesting title through searching, the title is selected in order to move straight into document display or selection. This is yet another way in which examiner-specific documents can be made accessible through area 604.

In one embodiment, an interface is provided that enables a user to customize the format of area 604, thereby customizing access to examiner-specific information. Customization may be global (e.g., applies across all accessed examiner data sheets) or specific (e.g., applies to only one examiner, only one art unit, etc.). In one embodiment, area 604 will have a default configuration when no configuration preferences have been expressed.

In a global customization example, a given user may input a request that all accessed data sheets 600 include an area within area 604 that displays assignees for which the relevant examiner has examined more than five cases in the last two years. System 106 translates this or any similar type of user preferences into a query against bibliographic data 410 and/or data 412. The results are displayed in a portion of area 604. The user can then access examiner-specific documents an assignee-specific basis as described above.

In a specific customization example, the same user may input a request that area 604 display, for all examiners in a particular art unit, all serial numbers for issued patents that contain the word “circuitry” in the title. System 106 translates this preference into a query against data 410 and/or 412. The results are displayed in area 604 when examiner data sheets are retrieved within the relevant art unit. The user can then access examiner-specific documents a serial number-specific basis as described above.

In one embodiment, system 106 provides an automatic notification functionality on a user specific basis. For example, a user can illustratively configure system 106 to initiate a notification whenever certain prescribed circumstances are detected. For example, a user can illustratively configure system 106 to send an email to a provided address whenever it is detected that a particular examiner (or an examiner in a particular art unit) has become affiliated with a case that satisfies certain criteria (e.g., has a particular word in the title, etc.). Those skilled in the art will understand this general concept and recognize the many options for actual implementation.

Examiner data sheet 600 also includes an area 606 within which survey-related information is displayed in a manner that is specific to the examiner that is the subject of sheet 600. Within area 606 (or within a related pop-up window, etc.), a user is illustratively able to cast a vote that serves as an expression of the user's opinion relative to the examiner in the context of an indicated survey topic. System 106 receives user input from multiple users and displays corresponding survey results within area 606.

In one embodiment, system 106 is configured to show how other users have voted only after the current user has voted. In another embodiment, however, survey results always appear regardless of whether the current user has voted. In this case, an indication of whether or not the user has voted may be provided. In one embodiment, system 106 is configured to provide an indication of the current user's vote. The user may or may not be allowed to change his or her vote. In one embodiment, there are restrictions placed on the right to change one's vote (e.g., you can only change once ever five days, etc.).

In one embodiment, system 106 is configured to implement user-specific restrictions on one's right to vote or change one's vote. For example, in one embodiment, system 106 determines identity characteristics based on a user's log-in password and implements restrictions accordingly. For example, an examiner may not be allowed to vote on any examiner data sheet 600, or at least may not be allowed to vote on his or her own data sheet 600. Those skilled in the art will recognize that the scope of the present invention extends to other similar identity-specific voting restrictions.

Examples of voting topics include but are not limited to the legal soundness of the examiner's rejections, the examiner's ability to communicate effectively in verbal communications, the examiner's ability to communicate effectively in written communications, the examiner's ability to move cases along efficiently, etc. As one specific example of a survey functionality with area 606, there may be an indication that 6 out of 10 users who have accessed the same examiner's data sheet have indicated that the legal soundness of the examiner's rejection of patent applications is perceived as being ranked at less than 5 on a 10 point scale with 10 being excellent and 1 being poor. Illustratively, the display is also indicative of the fact that the current user has already voted with an indication of 5 as the answer.

Examiner data sheet 600 also includes an area 608 within which statistical information is displayed in a manner that is specific to the examiner that is the subject of sheet 600. Once an examiner's related serial numbers have been determined (e.g., through examination of patent bibliographic data 410), manual and/or electronic queries can be conducted against data in the associated file histories in order to derive many interesting statistics to be displayed in area 608. For example, area 608 can indicate the number of patents issued by the examiner, the percentage of cases that have lead to an issued patent, the number of restriction requirements that exist in file histories associated with the examiner, the percentage of file histories that contain a restriction requirement, number and/or percentage of cases with rejections under a particular statute, etc. These and many other statistical values are illustratively determined through research relative to the data in either or both of data source 108 and 116. Those skilled in the art will appreciate that the present invention is not limited to the display of any particular kind of statistical data.

Examiner data sheet 600 also includes an area 610 that supports publication of user-authored comments relative to the examiner that is the subject of sheet 600. In one embodiment, area 610 simply provides a text box and a publication button. The user types in a comment, presses the publication button and the comment immediate is added to the bottom of data sheet 600 for all users to see whenever the same examiner's data sheet is published. In one embodiment, however, system 106 provides a “public” or “private” option that enables the user to decide whether the comment will be viewable to all users or just the authoring user. In other words, a user can publish a personal comment about the examiner that will only appear subsequently to the user that published it becoming essentially an examiner-specific note-to-self.

In one embodiment, system 106 provides an administrative tool with comment editing functionality. Through the tool, an administrator reviews some or all user-initiated public (i.e., not private) comments published through interaction in area 610 of a data sheet 600. In one embodiment, no publication of a public comment occurs until the administrator indicates approval. In another embodiment, publication of public comments is immediate but system 106 facilitates an administrator's ability to remove a public comment at any time. In one embodiment publication of public comments is immediate but is revoked automatically if an administrator does not indicate approval within a predetermined period of time (e.g., a period of time set by the administrator).

In one embodiment, a drop-box with suggestions for the nature of a comment is provided. The user selects a suggestion, types in a comment, and presses the publication button. The suggestion may or may not be published with the comment. In one embodiment, comments are to be restricted to one of the topics in the drop box.

In one embodiment, comment publication center 610 is configured to implement user-specific restrictions on one's right to comment. For example, in one embodiment, system 106 determines identity characteristics based on a user's log-in password and implements restrictions accordingly. For example, an examiner may not be allowed to comment on any examiner data sheet 600, or at least may not be allowed to comment on his or her own data sheet 600.

Those skilled in the art will recognize that the scope of the present invention extends to other identity-specific commenting system configurations. For example, in one embodiment, an examiner is allowed to comment on examiner data sheets 600. System 600 is illustratively configured to identify such a scenario and, when such comments are published, display an indication with the publication that the comment is from an examiner. In one embodiment, when an examiner publishes a comment on his or her own data sheet, an indication is provided with the publication that the comment is from the same examiner that is the focus of the data sheet.

In general, a purpose of system 106 is to provide registered users (e.g., user 102) with convenient and efficient access to examiner-specific information. Although the present invention has been described with reference to particular embodiments, workers skilled in the art will recognize that changes may be made in form and detail without departing from the spirit and scope of the invention.

What is claimed is:

1. A data accessing system, comprising:
a user interface, accessible over a wide area network and configured to receive a patent examiner identification input identifying a patent examiner, and a data request; and
a data search component configured to, in response to the data request, retrieve patent related writings generated by the patent examiner in prosecuting a plurality of different patent applications.

2. The data accessing system of claim 1 and further comprising:
a data store configured to store the patent related writings; and
wherein the data search component includes a patent office data interface configured to intermittently download the patent related writings to the data store.

3. The data accessing system of claim 2 wherein the patent related writings are indexed by patent examiner in the data store.

4. The data accessing system of claim 1 wherein the patent related writings are stored on a patent office data store and further comprising:
a patent office data interface configured to query the patent office data store for the patent related writings in response to the data request.

5. The data accessing system of claim 1 wherein the user interface is further configured to receive a biographical data request and wherein the data search component is configured to retrieve biographical data associated with the identified patent examiner.

6. The data accessing system of claim 1 wherein the user interface is configured to receive user comments related to the patent examiner.

7. The data accessing system of claim 6 wherein the data search component is configured to retrieve the user comments for review by subsequent users.

8. The data accessing system of claim 1 wherein the user interface is configured to receive survey response information indicative of user responses to survey questions regarding performance of the patent examiner.

9. The data accessing system of claim 8 wherein the data search component is configured to retrieve tallied survey results based on the user responses to the survey questions.

10. A method of accessing data, comprising:
receiving an examiner identifier identifying a patent examiner;
identifying relevant patent related writings, written by the identified patent examiner in prosecuting one or more patent applications, based on the identified patent examiner; and
presenting the identified patent related writings for review by the user.

11. The method of claim 10 wherein presenting the identified patent related writings comprises:
presenting actuable links to the patent related writings.

12. The method of claim 10 and further comprising:
identifying responses to the relevant patent related writings; and
presenting the responses for review by the user.

13. The method of claim 10 and further comprising:
identifying file histories of patent applications prosecuted by the identified patent examiner; and
presenting the file histories for review by the user.

14. The method of claim 10 and further comprising:
presenting biographical data corresponding to the identified patent examiner along with the relevant patent related writings for review by the user.

15. A business method, comprising:
registering a user;
receiving from the user a patent examiner identifier identifying a patent examiner;
providing electronic access to a set of office actions authored by the identified patent examiner; and
charging the user money.

16. The business method of claim 15 and further comprising:
intermittently downloading office actions from a patent office data store.

17. The business method of claim 16 and further comprising:
storing the downloaded office actions based on patent examiner.

18. The business method of claim 15 and further comprising:
providing electronic access to biographical data associated with the identified patent examiner.

19. The business method of claim 15 wherein registering the user comprises:
registering the user to have access to one of a plurality of different levels of content.

20. The business method of claim 19 wherein charging the user money comprises:
charging the user a different amount of money based on the level of content the user is registered to access.
